(19) United States
(12) Patent Application Publication
(10) Pub. No.: US 2007/0086800 A1
(43) Pub. Date: Apr. 19, 2007

(54) Image forming apparatus and a method for improving developing performance thereof

(75) Inventors: Yoo-seok Yang, Yongin-si (KR); Jin-cheol Kim, Suwon-si (KR); Joong-gwang Shin, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/384,357

(22) Filed: Mar. 21, 2006

(30) Foreign Application Priority Data
Oct. 18, 2005 (KR) 2005-0098088

(51) Int. Cl. G03G 15/00

(52) U.S. Cl. 399/49; 399/72

(57) ABSTRACT

An image forming apparatus includes at least one photoconductive medium on which an electrostatic latent image is formed; at least one developing device for developing the electrostatic latent image formed on the photoconductive medium with a developer to form a visible developer image, and a developing performance improving unit for controlling at least one of the photoconductive medium and the developing device to periodically form a patch developer image using developer that has uneven attributes (such as uneven coulomb per mass (Q/M)), and clean and remove the patch developer image. Accordingly, developer having uneven Q/M is periodically used for printing patch developer image and removed, thereby preventing the developer from being used for desired images, and thereby preventing inferior developing of desired images at the uneven-developer generating parts.

### CROSS-REFERENCE TO RELATED APPLICATIONS

This application claims the benefit under 35 U.S.C. § 119(a) of Korean Patent Application No. 2005-98088, filed Oct. 18, 2005, the entire contents of which are hereby incorporated by reference.

### BACKGROUND OF THE INVENTION

1. Field of the Invention

The present invention relates to an electrophotographic image forming apparatus such as a photocopier or a printer. More particularly, the present invention relates to an image forming apparatus with improved developing performance, and a method for the same.

2. Description of the Related Art

In general, electrophotographic image forming apparatuses such as photocopiers and printers form an electrostatic latent image on a photoconductive medium, for example, a photoconductive belt or a photoconductive drum. A developing unit then develops the electrostatic latent image with a developer having a predetermined color to form a developer image. The developer image is transferred onto an image receiving medium, such as paper. Accordingly, a desired image is produced.

In a mono-color type image forming apparatus, the developing unit comprises one developing device for a single color, for example, a black developing device for developing an electrostatic latent image corresponding to a black color into a visible image. In a multi-color type image forming apparatus, on the other hand, the developing unit comprises a plurality of developing devices, for example, yellow, magenta, cyan and black developing devices for developing electrostatic latent images corresponding to yellow (Y), magenta (M), cyan (C) and black (K), respectively.

FIGS. 1 and 2 show a typical developing device 10 (or developing unit) of an image forming apparatus.

As shown in FIG. 1, the developing device 10 comprises a developing roller 98, a developer supply roller 2, and a developing case 5.

The developing roller 98 forms a nip by contacting a photoconductive medium (not shown) with a predetermined pressure. The developer roller 98 develops an electrostatic latent image formed on the photoconductive medium, thereby forming a visible developer image.

The developer supply roller 2 forms a nip by contacting one side of the developing roller 98. The developer supply roller 2 supplies developer to the developing roller 98 by using a difference of electric potentials between the rollers.

As shown in FIG. 2, the developing case 5 rotatably supports opposite ends of shafts of the developing roller 98 and the developer supply roller 2.

A developer incoming part 6 is disposed at one side (on the right with respect to FIGS. 1 and 2) of the developing case 5, and is connected with a developer cartridge 30 (FIG. 3) that stores a developer having a predetermined color.

As shown in FIG. 3, the developer cartridge 30 comprises a developer container 31 for storing the developer, a rotary shaft 41 that receives a driving force from an external source through a rotary gear 42, at least one agitating wing 44 mounted to the rotary shaft 41, and a scroll part 48 rotated by the driving force of the rotary shaft 41.

A developer conveying belt 12 of a developer conveying member 11 is disposed at the developer incoming part 6 for delivering the developer discharged from an outlet 33a of a developer discharge part 33 of the developer container 31.

As shown in FIGS. 1 and 2, the developer conveying member 11 comprises the developer conveying belt 12, and first and second developer conveying augers 14 and 16.

The developer conveying belt 12 moves the developer dropping from the outlet 33a of the developer discharge part 33 of the developer container 31 toward the developer supply roller 2. To this end, the developer conveying belt 12 is rotated counterclockwise in FIG. 1 by a second driving pulley 18 which is driven by third and fourth auger gears 15 and 17 through a second idle gear 22 and a second pulley gear 18a. The third and the fourth auger gears 15 and 17 are driven by a developer supply roller gear 3 through a first idle gear 4. On an outer surface of the developer conveying belt 12, a plurality of scoopers 19 having a partition or wing form are formed to move the developer dropping onto the developer conveying belt 12 toward the first and the second developer conveying augers 14 and 16.

The first and the second developer conveying augers 14 and 16 are disposed between the developer supply roller 2 and the developer conveying belt 12 at predetermined intervals. The first and the second developer conveying augers 14 and 16 respectively comprise second and third auger shafts 20 and 21 mounting spiral flights 20a and 21a along the outer circumference thereof. The spiral flights 20a and 21a move the developer along the length of the developer supply roller 2 as shown by the arrows C and D in the drawing. The first and the second developer augers 14 and 16 are rotated in the opposite directions to each other by the third and the fourth auger gears 15 and 17 connected to the developer conveying roller gear 3 through the first idle gear 4. According to the rotation of the first and the second developer augers 14 and 16, the developer is moved in the opposite directions as shown by the arrows C and D along the length of the developer supply roller 2. In other words, the developer moves along a U-shaped path.

The operation of the above-structured developing device 10 will now be described.

First, the developer stored in the developer container 31 of the developer cartridge 30 is dropped to the developer conveying belt 12 disposed under an inlet 6a of the developer incoming part 6 through the outlet 33a of the developer discharge part 33 of the developer cartridge 30 by the agitating wing 44 and the scroll part 48 which are driven by a driving force of a cartridge power transmission part (not shown), transmitted through the rotary gear 42. The developer dropped on the developer conveying belt 12 is conveyed to the first developer conveying auger 14 by the scooper 19, moved in the directions C and D by the first and the second developer conveying augers 14 and 16, and supplied to the developer supply roller 2.

In the developing case 5, the developer supplied to the developer supply roller 2 is moved to a lower space between the developer supply roller 2 and the developing roller 98 by the developer supply roller 2.

The developer moved to the lower space between the developer supply roller 2 and the developing roller 98 is applied with an electric charge by the developer supply roller 2. Therefore, the developer is attached to the developing roller 98 having a relatively lower electric potential and is moved to the nip between the developer supply roller 2 and the developing roller 98.

After passing through the nip between the developer supply roller 2 and the developing roller 98, the developer attached to the developing roller 98 is controlled into a developer layer having a predetermined thickness and mass per area (M/A) by a developer controlling blade (not shown), and moved to the nip between the photoconductive medium and the developing roller 98.

Therefore, when the developer layer attached to the developing roller 98 contacts the photoconductive medium, a predetermined potential difference is generated between the electrostatic latent image formed on the photoconductive medium and having a low electric potential, and the developing roller 98. By the potential difference, part of the developer layer corresponding to the electrostatic latent image formed on the photoconductive medium by a laser scanning unit (LSU) (not shown) is attached to the electrostatic latent image. Accordingly, the electrostatic latent image is developed into a visual developer image.

In the above-structured developing device 10, when toner attributes of the developer layer formed on the developing roller 98, especially the MIA and coulomb per mass (Q/M), are uneven, development of the electrostatic latent image becomes uneven. In the worst case, development problems such as image deletions may occur. Therefore, it is important to maintain even M/A and Q/M of the developer layer on the developing roller 98.

However, the developing device 10 is structured to distribute and supply the developer conveyed by the developer conveying belt 12 through the first and the second developer conveying augers 14 and 16 that move the developer in the directions C and D, to the developer supply roller 2. With such a structure, the developer may not be mixed well, and may remain at both ends of the developer supply roller 2 and the developing roller 98. As a result, the developer disposed at both ends of the developer supply roller 2 and the developer 98 cannot be electrified sufficiently by the developer supply roller 2, thereby having lower Q/M than the developer disposed at the center. Especially when the developing device 10 has not been used for a long time, the Q/M of the developer layer disposed at the both sides of the developer supply roller 2 and the developing roller 98 becomes very low. Therefore, when the electrostatic latent image on the photoconductive medium is developed by the developing roller 98, the developer layer disposed at the both sides of the developing roller 98 has different M/A or uneven Q/M with respect to the center. Consequently, the development of the electrostatic latent image of the photoconductive medium at both ends of the developing roller 98 may be inferior.

Accordingly, there is a need for an image forming apparatus which improves the development of electrostatic latent images, particularly at the ends of the developing roller.

### SUMMARY OF THE INVENTION

An aspect of the present invention is to address at least the above problems and/or disadvantages and to provide at least the advantages described below. Accordingly, an aspect of the present invention is to provide an image forming apparatus capable of preventing inferior developing caused by poorly mixed and stagnant developer at uneven-developer generating parts (such as both ends of a developing device) and accordingly having uneven attributes (such as coulomb per mass (Q/M)), and a method for improving developing performance thereof.

In accordance with an aspect of the present invention, an image forming apparatus comprises at least one photoconductive medium on which an electrostatic latent image is formed, at least one developing device for developing the electrostatic latent image formed on the photoconductive medium with developer, thereby forming a visible developer image, and a developing performance improving unit for controlling at least one of the photoconductive medium and the developing device to periodically form a patch developer image using a developer having uneven coulomb per mass (Q/M), and clean and remove the formed patch developer image.

The developing performance improving unit may comprise a controller which controls at least one of the photoconductive medium and the developing device to form at predetermined periods a patch developer image having a predetermined pattern and a predetermined image coverage, that can be developed by an uneven-developer generating part where the developer having uneven Q/M is generated, and clean and remove the patch developer image.

The uneven-developer generating part of the developing device may comprise both ends of a developing roller that develops the electrostatic latent image formed on the photoconductive medium.

The predetermined period may comprise a period set as a preset reference number of printed papers.

The predetermined pattern may comprise at least one patch formed as a band having a predetermined width and length and arranged perpendicularly to an axial direction of the developing roller to correspond to both ends of the developing roller.

The predetermined image coverage is within a range of 0˜100%.

The image forming apparatus may further comprise an image transfer belt including an image transfer surface on which the developer image formed on the photoconductive medium is transferred, and a cleaner that cleans and removes the developer image transferred on the image transfer surface. The developing performance improving unit may further comprise an image coverage detecting unit arranged to face the image transfer surface and measure the image coverage of the patch developer image transferred on the image transfer belt.

The controller may control at least one of the photoconductive medium, the developing device, the image transfer belt and the cleaner to form the patch developer image continuously until the image coverage of the patch developer image measured by the image coverage detecting unit reaches a preset reference level, and cleans and removes the formed patch developer image.

The reference level may be set equal to or greater than 80% of the predetermined image coverage.

The image coverage detecting unit may comprises at least one photosensor for measuring the image coverage of the patch developer image by optical reflectance.

In accordance with another aspect of the present invention, a method for improving developing performance of an image forming apparatus, comprises the steps of determining whether a predetermined period is passed to form a patch developer image for improving developing performance, forming a patch developer image using developer having uneven Q/M when it is determined that the predetermined period is passed, and removing the formed patch developer image.

The determining step may comprise determining whether the number of printed papers printed by the image forming apparatus reaches a preset reference number of printed papers.

The forming step may comprise forming an electrostatic latent image on a photoconductive medium, which can be developed according to predetermined pattern and image coverage, corresponding to an uneven-developer generating part of a developing device, where the developer having uneven Q/M is generated, forming a patch developer image by developing the electrostatic latent image using the developer having the uneven Q/M generated by the uneven-developer generating part, and transferring the patch developer image onto an image transfer surface of the image transfer belt.

The uneven-developer generating part of the developing device may comprise both ends of a developing roller that develops the electrostatic latent image formed on the photoconductive medium.

The predetermined pattern may comprise at least one patch formed as a band having a predetermined width and length and arranged perpendicularly to an axial direction of the developing roller to correspond to both ends of the developing roller.

The predetermined image coverage may be within a range of 0˜100%.

The removing step may comprise removing the patch developer image transferred on the image transfer surface of the image transfer belt by cleaning with a cleaner.

The method further comprise the step of measuring an image coverage of the patch developer image transferred on the image transfer belt, by an image coverage detecting unit disposed to correspond to the image transfer surface of the image transfer belt.

The step of forming a patch developer image may comprise forming the patch developer image continuously until the image coverage of the patch developer image measured by the image coverage detecting unit reaches a preset reference level.

The image coverage detecting unit may comprise at least one photosensor for measuring the image coverage of the patch developer image by optical reflectance.

The reference level may be set equal to or greater than 80% of the predetermined image coverage.

### BRIEF DESCRIPTION OF THE DRAWING FIGURES

The above and other objects, features, and advantages of certain exemplary embodiments of the present invention will be more apparent from the following description taken in conjunction with the accompanying drawings, in which:

FIG. 1 is a side-sectional view of a conventional developing device forming a developing unit of an image forming apparatus;

FIG. 2 is a top cross-sectional view of the developing device of FIG. 1;

FIG. 3 is a partial sectional view of a developer cartridge connected to the developing device of FIG. 1;

FIG. 4 is a schematic view of an electrophotographic color printer according to an exemplary embodiment of the present invention;

FIG. 5 is a perspective view of an image forming process module for the electrophotographic color printer of FIG. 4;

FIG. 6 is a conceptual view showing the operation of the electrophotographic color printer of FIG. 4; and

FIG. 7 is a flowchart of a method for improving developing performance of an electrophotographic color printer according to an exemplary embodiment of the present invention.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

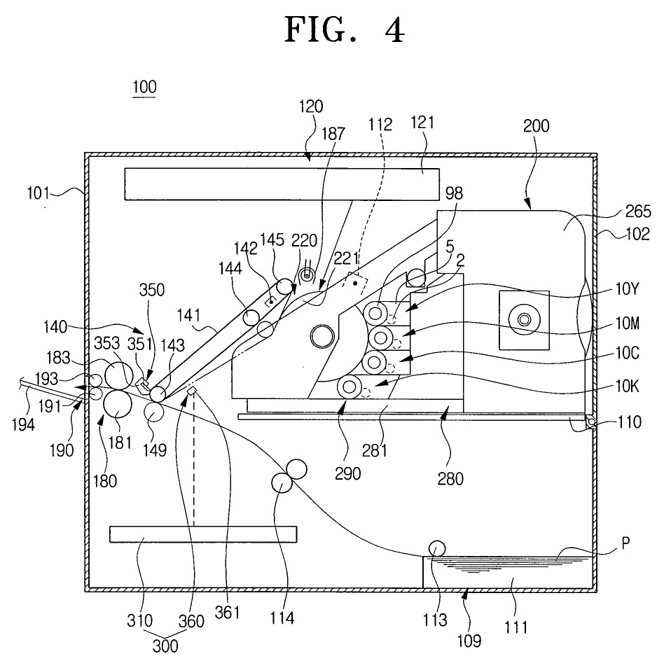

FIG. 4 shows an image forming apparatus capable of improving developing performance thereof, according to an exemplary embodiment of the present invention.

According to an exemplary embodiment of the present invention, a color image forming apparatus is an electrophotographic color printer 100 that performs a printing operation by internally processing image information transmitted from devices such as a computer (not shown) and a scanner (not shown).

As shown in FIG. 4, the color printer 100 comprises a paper feeding unit 109, an image formation unit 120, a transfer unit 140, a developing performance improving unit 300, a fixing unit 180, and a paper discharge unit 190.

The paper feeding unit 109 replenishes image receiving medium P such as paper and comprises a paper supply cassette 111, a pickup roller 113, and a registration roller 114. The paper supply cassette 111 is disposed at a lower part of a main body 101. The image receiving medium P stacked in the paper supply cassette 111 is picked up by the pickup roller 113 and conveyed to the registration roller 114.

The image formation unit 120 is disposed at an upper part of the paper feeding unit 109 to form developer images in predetermined colors such as cyan (C), magenta (M), yellow (Y) and black (K) on the image receiving medium P.

The image formation unit 120 comprises an image forming process module 200 detachably mounted to a main frame 110 of the main body 101.

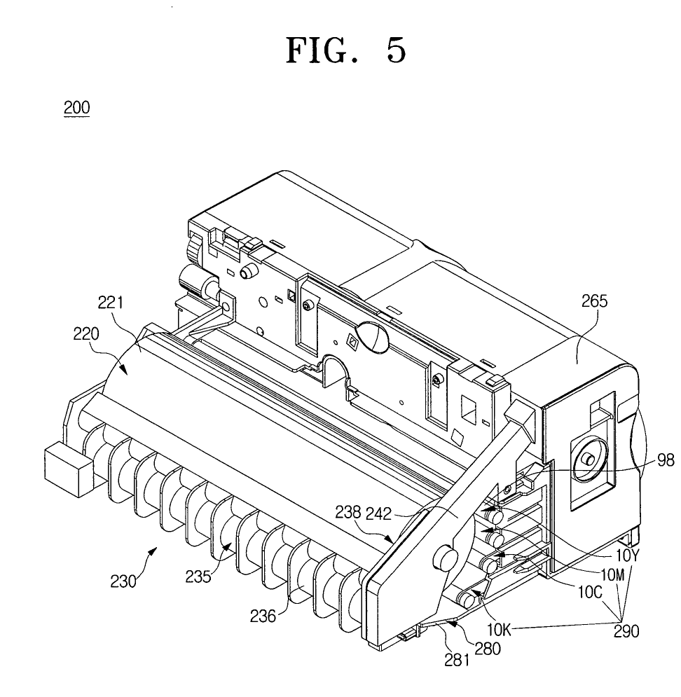

As shown in FIG. 5, the image forming process module 200 comprises a photoconductive unit 220 and a developing unit 290 which are integrally modularized by and fixed to a fixing frame 280.

The photoconductive unit 220 comprises a photoconductive medium 221. The photoconductive medium 221 is, for example, an organic photoconductive (OPC) drum that comprises an aluminum cylinder coated with an organic photoconductive layer. The photoconductive medium 221 is rotatably supported at its ends by first and second flanges (not shown) formed on a bottom plate 281 of the fixing frame 280. The photoconductive medium 221 forms a nip by contacting an image transfer belt 141 at a predetermined pressure (which is maintained by a tension roller 144 of the transfer unit 140). In addition, the photoconductive medium 221 is rotated in one direction, for example, counterclockwise, by a photoconductive medium gear train (not shown) which receives power from a driving gear train (not shown) of a photoconductive medium driving motor (not shown) mounted to the main frame 110 of the main body 101. Since the structures of the driving gear train and the photoconductive medium gear train are generally known in the art, a detailed description will be omitted for conciseness.

A photoconductive medium cleaner 230 for cleaning a surface of the photoconductive medium 221 is disposed at one side (on the left in FIG. 5) of a lower part of the photoconductive medium 221.

The photoconductive medium cleaner 230 removes waste toner remaining on the surface of the image transfer belt 141 of the transfer unit 140 after a color developer image formed on the photoconductive medium 221 is transferred. For this purpose, the photoconductive medium cleaner 230 comprises a cleaning member (not shown) such as a cleaning blade and a waste toner storage unit 235.

The cleaning member is pivotably mounted in a waste toner collector 236 of the waste toner storage unit 235. During the cleaning operation, the cleaning member is reciprocated by a solenoid (not shown), thereby contacting and moving away from the photoconductive medium 221.

The waste toner storage unit 235 stores the waste toner removed from the surface of the photoconductive medium 221 by the cleaning member. To this end, the waste toner storage unit 235 comprises the developer conveying collector 236 that collects the waste toner removed by the cleaning member, a waste toner conveying member 238 that has a connection pipe 242 for moving the waste toner collected by the waste toner collector 236 to a waste toner container 265, and the waste toner container 265 for storing the waste toner moved by a waste toner conveying belt (not shown) in the connection pipe 242.

The developing unit 290 is disposed at the other side (on the right in FIGS. 4 and 5) of the photoconductive medium 221 on the bottom plate 281 of the fixing frame 280.

The developing unit 290 comprises a plurality of developing devices, for example, Y, M, C and K-developing devices 10Y, 10M, 10C, and 10K for forming a visible developer image by developing a plurality of electrostatic latent images, for example, corresponding to yellow (Y), magenta (M), cyan (C), and black (K) in an overlapping manner.

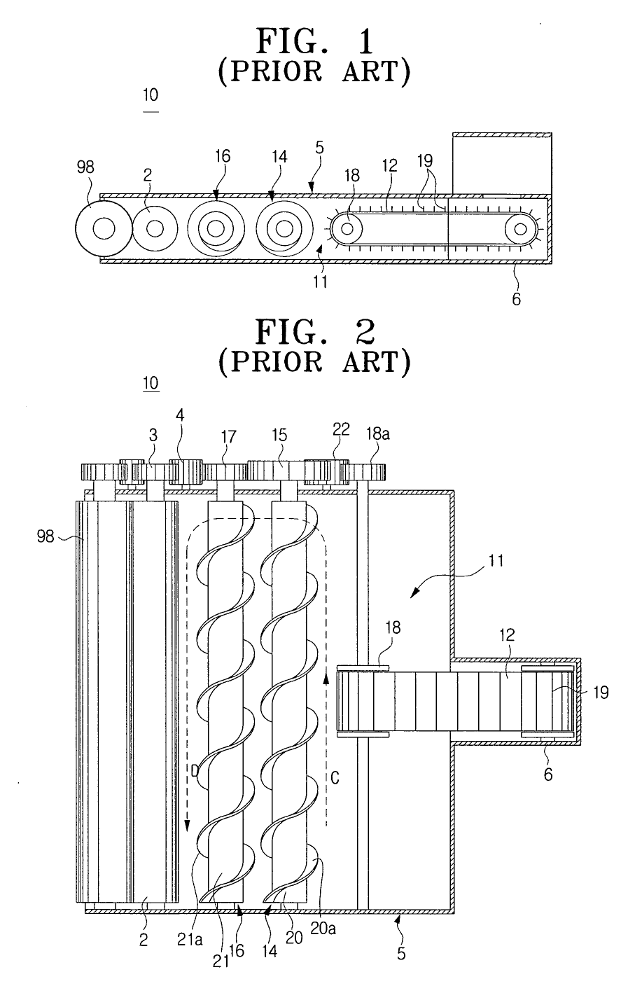

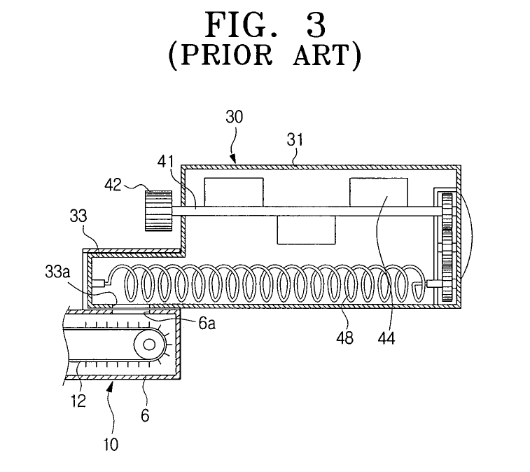

The developing devices 10Y, 10M, 10C, and 10K respectively comprise a developing roller 98, a developer supply roller 2, and a developing case 5. The respective developing devices 10Y, 10M, 10C, and 10K have the same structure as the developing device 10 as described with reference to FIGS. 1 through 3. Therefore, a detailed description will not be repeated.

Referring back to FIG. 4, an electrifying unit 112, a laser scan unit (LSU) 121, an erasing unit 187, and the transfer unit 140 are properly arranged near the upper outer circumference of the photoconductive medium 221 along rotational directions thereof.

The electrifying unit 112 comprises a scorotron electrifier spaced at a certain interval from the surface of the photoconductive medium 221. An electrifying bias power unit (not shown) applies an electrifying bias voltage to the electrifying unit 112 so that the electrifying unit 112 creates an electrifying potential on the surface of the photoconductive medium 221.

The LSU 121 scans the surface of the charged photoconductive medium 221 with a laser beam using a laser diode, according to image signals input from external devices such as a computer and a scanner, thereby forming an electrostatic latent image having a lower electric potential than the electrifying potential.

The erasing unit 187 removes the electrifying potential on the surface of the photoconductive medium 221 and comprises an erasing lamp.

The transfer unit 140 transfers the color developer image formed on the surface of the photoconductive medium 221 onto the image receiving medium P. The transfer unit 140 comprises the image transfer belt 141, a transfer voltage applying member 142, and a transfer roller 149.

The image transfer belt 141 transfers the color developer image formed on the photoconductive medium 221 to the image receiving medium P. To do this, the image transfer belt 141 is configured to rotate in a direction for the image receiving medium P to be fed by a driving roller 143, the tension roller 144, and a driven roller 145, that is, a clockwise direction, with reference to FIG. 4.

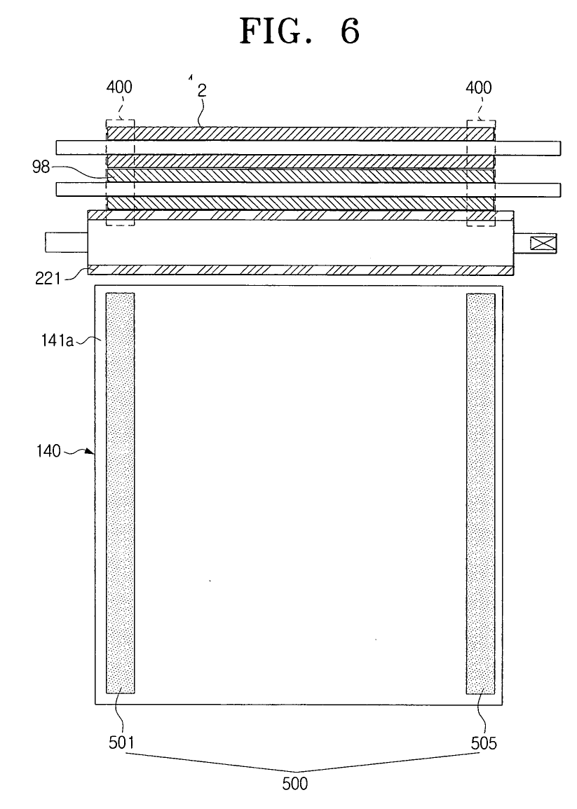

An image transfer surface 141a (FIG. 6) coated with the organic photoconductive layer is formed on a surface of the image transfer belt 141 so that the color developer image can be transferred thereto from the photoconductive medium 221.

A belt cleaner 350 contacts the image transfer belt 141 in the vicinity of the driving roller 143 to remove waste toner remaining on the surface of the image transfer belt 141 after the image transfer belt 141 transfers the color developer image onto the image receiving medium P. The belt cleaner 350 comprises a belt cleaning blade 351 for cleaning the image transfer surface 141a, and a waste toner case 353 for collecting the waste toner removed by the belt leaning blade 351.

A transfer bias power unit (not shown) applies a first transfer bias voltage to the transfer voltage applying member 142 so as to transfer the color developer image formed on the photoconductive medium 221 onto the image transfer belt 141.

The transfer roller 149 and the driving roller 143 are configured to press the image receiving medium P into contact with the image transfer belt 141 so as to transfer the color developer image transferred on the image transfer belt 141 onto the image receiving medium P. The transfer bias power unit applies a second transfer bias voltage to the transfer roller 149 so that the color developer image on the image transfer belt 141 can be transferred onto the image receiving medium P.

The developing performance improving unit 300 is provided to prevent inferior developing caused by the developer having uneven coulomb per mass (Q/M) generated by poor mixing and stagnancy of the developer at uneven-developer generating parts 400 (FIG. 6), such as at both ends of the developer supply roller 2 and the developing roller 98 in the respective developing devices 10Y, 10M, 10C, and 10K.

More specifically, as described with respect to FIGS. 1 through 3, developer is moved from the developer conveying belt 12 through the first and the second developer conveying augers 14 and 16 that move the developer in the arrowed directions C and D, respectively, and the developing devices 10Y, 10M, 10C, and 10K are configured to distribute and supply the developer to the developer supply roller 2. According to this structure of the first and the second developer conveying augers 14 and 16, the developer may be insufficiently mixed and may stagnate at both sides of the developer supply roller 2 and the developing roller 98. As a result, as shown in FIG. 6, when the electrostatic latent image on the photoconductive medium 221 is developed by the developing roller 98, a developer layer formed at the uneven-developer generating parts 400 may have different mass per area (M/A) and/or uneven coulomb per mass (Q/M) with respect to the center of the developing roller 98.

In order to address such problems, at predetermined periods, the developing performance improving unit 300 controls the photoconductive medium 221, the respective developing devices 10Y, 10M, 10C, and 10K, the image transfer belt 141 and the like to form Y, M, C, and K-patch developer images at the ends of the developer supply roller 2 and the developing roller 98 of the respective developing devices 10Y, 10M, 10C, and 10K. The patch developer images are then removed, thereby preventing inferior developing at the uneven-developer generating parts 400.

More particularly, the developing performance improving unit 300 may comprise a controller 310 (such as a microprocessor) that improves the developing performance by periodically controlling the photoconductive medium 221, the respective developing devices 10Y, 10M, 10C, and 10K, the image transfer belt 141 and the like to form Y, M, C, and K-patch developer images having a predetermined pattern 500 (FIG. 6) and image coverage at the uneven-developer generating parts 400 of the respective developing devices 10Y, 10M, 10C, and 10K, and then develop, clean and remove the patch developer images. The controller may perform the formation, developing, cleaning, and removal of the patch developer images at predetermined periods.

The controller 310 controls the overall operation of the image forming apparatus 100 and is mounted to a circuit board (not shown) at a lower part of the main body 101.

The controller 310 controls the photoconductive medium 221, the respective developing devices 10Y, 10M, 10C, and 10K, the image transfer belt 141 and the like to separately form the Y, M, C, and K-patch developer images on the photoconductive medium 221, separately transfer the Y, M, C, and K-patch developer images formed on the photoconductive medium 221 onto the image transfer belt 141, and remove the respective Y, M, C, and K-patch developer images transferred onto the image transfer belt 141 by the belt cleaner 350.

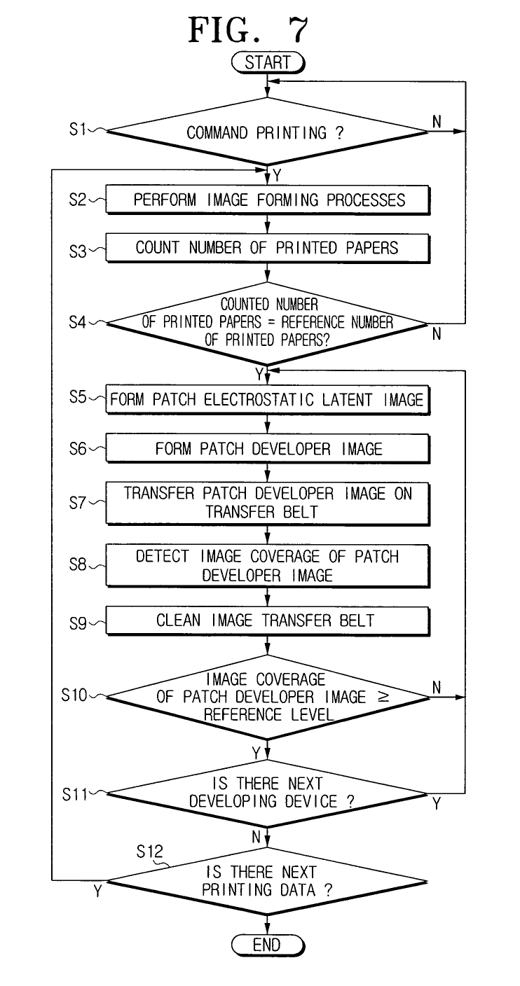

The predetermined period for forming a patch developer image may be a time interval. In an exemplary embodiment, however, the period is set as the number of printed papers in which inferior developing occurs at the uneven-developer generating parts 400. The period may be experimentally determined, and may be, for example, 100 sheets. The number of printed papers is stored in a memory of the controller 310 as a reference number of printed papers. Therefore, whenever the printer 100 prints out a sheet of the image receiving medium P, the controller 310 counts the number of printed papers using a counting circuit (not shown) installed therein, and when the counted number reaches the reference number of printed papers, performs the operation for improving developing performance that will be described below in greater detail with respect to FIG. 7.

As shown in FIG. 6, the predetermined pattern 500 of the Y, M, C, and K-patch developer images are configured so that the patch developer images can be formed on the photoconductive medium 221 by the uneven-developer generating parts 400, which generate the developer layer having uneven Q/M, and be transferred onto the image transfer surface 141a of the image transfer belt 141. Therefore, the predetermined pattern 500 may comprise a pair of patches 501 and 505 arranged perpendicularly to an axial direction of the developing roller 98 to correspond to both ends of the developing roller 98. Each patch 501 and 505 is preferably formed as a band having regular width and length, for example, width and length of approximately 25×290 mm.

The predetermined image coverage is preferably set within a range of 0˜100%. For example, the image coverage may be set to 100%. The image coverage, herein, refers to a percentage of an area where the developer is printed with respect to a predetermined unit area, for example, 10×10 mm.

The predetermined period, pattern, and image coverage set as described above may be pre-stored in the memory (not shown) of the controller 310.

The developing performance improving unit 300 may further comprise an image coverage detecting unit 360 for measuring the image coverage of the respective Y, M, C, and K-patch developer images transferred on the image transfer surface 141a of the image transfer belt 141.

In this case, the controller 310 compares the respective image coverage of the Y, M, C, and K-patch developer images as measured by the image coverage detecting unit 360 to a reference level predetermined and pre-stored in the memory. When the image coverage of the patch developer images is lower than the reference level, the controller 310 controls the photoconductive medium 221, the respective developing devices 10Y, 10M, 10C, and 10K, the image transfer belt 141 and the like to perform the developing performance improving operations continuously until the measured image coverage reaches the reference level. The reference level of the image coverage may be set equal to or greater than 80% of the predetermined image coverage. For example, when the predetermined image coverage is 100%, the reference level of the measured image coverage may be set to 80%. The reference level of the image coverage may be pre-stored in the memory of the controller 310.

The image coverage detecting unit 360 may comprise a pair of photosensors 361 arranged in the main body 101 at a certain interval from each other to correspond to the Y, M, C, and K-patch developer images transferred onto the image transfer surface 141a of the image transfer belt 141. Each photosensor 361 measures the image coverage of the respective Y, M, C, and K-patch developer images by measuring optical reflectance. The photosensors 361 may be conventional photosensors comprising a light receiving element and a light emitting element.

As described above, the developing performance improving unit 300 periodically removes, by printing patch developer images, developer with uneven Q/M caused by poor mixing and stagnancy of the developer generated at the uneven-developer generating parts 400 thereby preventing inferior developing by the poorly mixed and stagnant developer at the uneven-developer generating parts 400.

The fixing unit 180 fixes the color developer image transferred on the image receiving medium P onto the image receiving medium P. To do this, the fixing unit 180 comprises a heating roller 181 and a pressing roller 183. The heating roller 181 includes a heater (not shown) to fuse and fix the developer image onto the image receiving medium P at a high temperature. The pressing roller 183 is biased toward the heating roller 181 by a resilient pressing member (not shown) so as to press the image receiving medium P.

The paper discharge unit 190 comprises a discharge roller 191 and a backup roller 193 to eject the image receiving medium P to a discharged-paper tray 194.

Although the image forming apparatus according to an exemplary embodiment of the present invention has been described so far as an electrophotographic printer 100 comprising an image formation process module 200 which includes a photoconductive unit 220 including one photoconductive medium 221 and a developing unit 290 comprising a plurality of the developing devices 10Y, 10M, 10C, and 10K arranged to correspond to the photoconductive medium 221, the present invention is not limited to the particular structure of this exemplary embodiment. In other words, the image forming apparatus of the present invention is applicable to other image forming apparatuses using similar structures and principles. For example, the present invention is also applicable to an image forming apparatus that uses a plurality of photoconductive mediums with a plurality of corresponding developing devices.

Furthermore, in the above description of an exemplary embodiment of the present invention, the electrophotographic color image forming apparatus 100 utilizes an intermediate transfer belt (image transfer belt 141), instead of directly transferring an image to the image receiving medium P. The present invention, however, is not limited to this structure, and can also be applied to other types of color image forming apparatuses, such as those that transfer the color developer image formed on a photoconductive medium directly onto an image receiving medium P conveyed by a medium conveying belt having an image formation surface.

Moreover, in the above description of an exemplary embodiment of the present invention, the Y, M, C, and K-patch developer images are formed by the corresponding developing devices 10Y, 10M, 10C, and 10K, respectively, on the photoconductive medium 221, the images are then transferred from the photoconductive medium 221 onto the image transfer belt 141, and the Y, M, C, and K-patch developer images are then removed from the image transfer belt 141 by a belt cleaner 350. Alternatively, however, the patch developer images may be formed on the photoconductive medium 221 and then removed by a photoconductive medium cleaner 230 (FIG. 5). In this case, an image coverage detecting unit (not shown) for measuring the image coverage of the patch developer images is mounted with respect to the photoconductive medium 221 instead of with respect to the image transfer belt 141.

Also, in the above description of an exemplary embodiment of the present invention, the belt cleaner 350 removes the patch developer images from the image transfer belt 141. The present invention is not limited to this configuration, however. For example, a dedicated belt cleaner may be provided between the image coverage detecting unit 360 and the transfer roller 149 to contact the image transfer surface 141a as required, thereby cleaning and removing the Y, M, C, and K-patch developer images on the image transfer surface 141a.

In addition, the image forming apparatus according to an exemplary embodiment of the present invention may be applied to a duplex-printing color image forming apparatus (not shown) as well as a simplex-printing color image forming apparatus.

The method for improving developing performance of the electrophotographic color printer 100 according to an exemplary embodiment of the present invention will now be described with reference to FIG. 7.

When a printing command is issued (S1), the respective parts of the paper feeding unit 109, the image formation unit 120, the transfer unit 140, the fixing unit 180, and the paper discharge unit 190 perform a series of image forming processes under the control of the controller 310, thereby producing a color image on the image receiving medium P (S2). The image forming processes are the same as conventional image forming processes, and therefore will not be described in detail.

Whenever a sheet of the image receiving medium P is printed out in step S2, the controller 310 counts the number of printed papers of the image receiving medium P through the counting circuit (S3).

The controller 310 compares the number of printed papers counted through the counting circuit with the reference number of printed papers which is stored in the memory, for example, 100 sheets (S4), so as to determine whether a predetermined period has passed to form the Y, M, C and K patch developer images for improving the developing performance of the respective developing devices 10Y, 10M, 10C, and 10K.

When the counted number of printed papers equals the reference number of printed papers (for example, 100 sheets), the controller 310 performs the operations for improving the developing performance of the developing devices 10Y, 10M, 10C, and 10K (S5 through S11) to prevent inferior developing caused by the Y, M, C, and K developers having uneven Q/M at the uneven-developer generating parts 400.

More particularly, the surface of the photoconductive medium 221, which is evenly charged by the electrifying unit 112, is exposed to light by the LSU 121, which is controlled by the controller 310. Accordingly, an electrostatic latent image for a first-produced color that can be developed according to the predetermined pattern 500 and the predetermined image coverage, for example, a Y-electrostatic latent image for developing a Y-patch developer image is formed (S5). As shown in FIG. 6, the predetermined pattern 500 comprises two patches 501 and 505 arranged perpendicularly to an axial direction of the developing roller 98 to correspond to both ends of the developing roller 98 and formed as a band which is, for example, approximately 25 mm wide and 290 mm long. The predetermined image coverage is set within a range of 0˜100%. For example, the image coverage may be set to 100%.

When a leading end of the Y-electrostatic latent image reaches a developing position of the Y-developing device 10Y, the Y-electrostatic latent image is developed into the Y-patch developer image by Y-developer supplied from a Y-developer cartridge 30 by the developing roller 98 of the Y-developing device 10Y (S6).

The Y-patch developer image formed on the photoconductive medium 221 is transferred onto the image transfer surface 141a of the image transfer belt 141 by the first transfer voltage applied by the transfer voltage applying member 142 of the transfer unit 140, as shown in FIG. 6 (S7).

Next, the electrifying potential of the photoconductive medium 221 is removed by the erasing unit 187. The waste toner remaining on the surface of the photoconductive medium 221 is removed by the cleaning member of the photoconductive medium cleaner 230 which is operated by a solenoid. Accordingly, the photoconductive medium 221 is restored to an initial state.

As the image transfer belt 141 rotates, the Y-patch developer image transferred onto the image transfer surface 141 a of the image transfer belt 141 is passed through the image coverage detecting unit 360. As a consequence, the image coverage detecting unit 360 detects the image coverage of the Y-patch developer image and transmits a detection signal to the controller 310 (S 8).

After the image coverage of the Y-patch developer image is detected by the image coverage detecting unit 360, the image transfer belt 141 keeps rotating and accordingly, the Y-patch developer image transferred on the image transfer surface 141a is passed through the transfer nip between the image transfer belt 141 and the transfer roller 149 which are not applied with the second transfer bias voltage under control of the transfer bias power unit, and then removed by the belt cleaner 350. As a result, the image transfer belt 141 is restored to an initial state (S9)

Further, the controller 310 determines the image coverage of the Y-patch developer image according to the detection signal transmitted from the image coverage detecting unit 360, and compares the image determined coverage of the Y-patch developer image with the reference level of the image coverage pre-stored in the memory (S10). Here, the reference level is set equal to or greater than 80% of the predetermined image coverage and stored in the memory of the controller 310.

As a result of the comparison in step S10, when it is determined that the determined image coverage of the Y-patch developer image is lower than the reference level, that is, 80% of the predetermined image coverage, the controller 310 repeats the operations of steps S5 through S9.

When it is determined that the determined image coverage of the Y-patch developer image is equal to or greater than 80%, the controller 310 determines whether there is a developing device for the next color, that is, the M-developing device 10M (S11). When it is determined that there is a M-developing device 10M, the controller 310 performs the operations of steps S5 through S10, thereby improving the developing performance of the M-developing device 10M.

After the developing performance improving operations for the M-developing device, the controller 310 performs developing performance improving operations with respect to the next developing devices, that is, the C-developing device 10C and the K-developing device 10K, by repeating the operations of steps S5 through S10.

After completing the developing performance improving operations with respect to the developing devices 10Y, 10M, 10C, and 10K, the controller 310 determines whether there is further printing data (S12). When it is determined that further printing data exists, the controller 310 repeats the operations from step S2.

As a result of the determination in step S12, when it is determined that there is no more printing data, the controller 310 finishes the operations of the printer 100.

As can be appreciated from the above description of the image forming apparatus and the method for improving developing performance thereof, according to an exemplary embodiment of the present invention, the developer having uneven Q/M caused by poor mixing and stagnancy of the developer due to the configuration of the uneven-developer generating parts 400 is periodically used for printing a patch developer image and removed, thereby preventing inferior developing from occurring at the uneven-developer generating parts.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image forming apparatus comprising:
at least one photoconductive medium on which an electrostatic latent image is formed;
at least one developing device for developing the electrostatic latent image formed on the photoconductive medium with a developer to form a visible developer image; and
a developing performance improving unit for controlling at least one of the photoconductive medium and the developing device to periodically form a patch developer image using developer having uneven attributes, and clean and remove the formed patch developer image.

2. The image forming apparatus of claim 1, wherein the uneven attributes comprises uneven coulomb per mass (Q/M).

3. The image forming apparatus of claim 2, wherein the developing performance improving unit comprises a controller which controls at least one of the photoconductive medium and the developing device to form at predetermined periods a patch developer image having a predetermined pattern and a predetermined image coverage, that can be developed by an uneven-developer generating part where developer having uneven Q/M is generated, and clean and remove the formed patch developer image.

4. The image forming apparatus of claim 3, wherein the uneven-developer generating part of the developing device comprises both ends of a developing roller that develops the electrostatic latent image formed on the photoconductive medium.

5. The image forming apparatus of claim 3, wherein the predetermined period comprises a reference number of printed papers.

6. The image forming apparatus of claim 4, wherein the predetermined pattern comprises at least one patch formed as a band arranged perpendicularly to an axial direction of the developing roller to correspond to both ends of the developing roller.

7. The image forming apparatus of claim 3, wherein the predetermined image coverage is within a range of 0˜100%.

8. The image forming apparatus of claim 3, further comprising:
an image transfer belt including an image transfer surface on which the developer image formed on the photoconductive medium is transferred; and
a cleaner that cleans and removes the developer image transferred on the image transfer surface; and
an image coverage detecting unit arranged to face the image transfer surface and measure the image coverage of the patch developer image transferred on the image transfer belt.

9. The image forming apparatus of claim 8, wherein the controller controls at least one of the photoconductive medium, the developing device, the image transfer belt and the cleaner to form the patch developer image continuously until the image coverage of the patch developer image measured by the image coverage detecting unit reaches a preset reference level, and cleans and removes the formed patch developer image.

10. The image forming apparatus of claim 9, wherein the reference level is equal to or greater than 80% of the predetermined image coverage.

11. The image forming apparatus of claim 8, wherein the image coverage detecting unit comprises at least one photosensor measuring the image coverage of the patch developer image by optical reflectance.

12. A method for improving developing performance of an image forming apparatus, comprising the steps of:
determining whether a predetermined period to form a patch developer image for improving developing performance has passed;
forming a patch developer image using developer having uneven attributes when the predetermined period has passed; and
removing the formed patch developer image.

13. The method of claim 12, wherein the uneven attributes comprises uneven coulomb per mass (Q/M).

14. The method of claim 13, wherein the determining step comprises determining whether the number of sheets printed by the image forming apparatus has reached a preset reference number of sheets.

15. The method of claim 13, wherein the forming step comprises the steps of:
forming an electrostatic latent image on a photoconductive medium, which is to be developed according to predetermined pattern and image coverage, corresponding to an uneven-developer generating part of a developing device;
forming a patch developer image by developing the electrostatic latent image using developer having uneven Q/M generated by the uneven-developer generating part; and
transferring the patch developer image onto an image transfer surface of an image transfer belt.

16. The method of claim 15, wherein the uneven-developer generating part of the developing device comprises both ends of a developing roller that develops the electrostatic latent image formed on the photoconductive medium.

17. The method of claim 16, wherein the predetermined pattern comprises at least one patch formed as a band arranged perpendicularly to an axial direction of the developing roller to correspond to both ends of the developing roller.

18. The method of claim 15, wherein the predetermined image coverage is within a range of 0˜100%.

19. The method of claim 15, wherein the removing step comprises removing the patch developer image transferred on the image transfer surface of the image transfer belt by cleaning with a cleaner.

20. The method of claim 15, further comprising measuring an image coverage of the patch developer image transferred on the image transfer belt with an image coverage detecting unit disposed to correspond to the image transfer surface of the image transfer belt.

21. The method of claim 20, wherein the step of forming a patch developer image comprises forming the patch developer image continuously until the image coverage of the patch developer image measured by the image coverage detecting unit reaches a preset reference level.

22. The method of claim 21, wherein the image coverage detecting unit comprises at least one photosensor for measuring the image coverage of the patch developer image by optical reflectance.

23. The method of claim 21, wherein the reference level is equal to or greater than 80% of the predetermined image coverage.
